(19) United States
(12) Patent Application Publication
(10) Pub. No.: US 2009/0268165 A1
(43) Pub. Date: Oct. 29, 2009

(54) OPTICAL ENGINE

(75) Inventors: Wei Shen, Tainan County (TW); Chia-Yu Hu, Tainan County (TW); Chun-Min Chen, Tainan County (TW); Chun-Hao Su, Tainan County (TW)

Correspondence Address: J C PATENTS, 4 VENTURE, SUITE 250, IRVINE, CA, 92618, US

(73) Assignee: HIMAX DISPLAY, INC., Tainan County (TW)

(21) Appl. No.: 12/110,878

(22) Filed: Apr. 28, 2008

(51) Int. Cl. G03B 21/14

(52) U.S. Cl. 353/20

(57) ABSTRACT

An optical engine including a light source, a polarizing beam splitter (PBS), a multi-focus lens, and a light valve is provided. The light source is capable of emitting an illumination beam. The PBS is disposed on the light path of the illumination beam. The multi-focus lens is disposed on the light path of the illumination beam between the light source and the PBS, and has a plurality of refractive portions. The refractive portions have different effective focal lengths from one another. The PBS allows at least a part of the illumination beam with a first polarization direction to travel to the light valve. The light valve is capable of reflecting the part of the illumination beam and converting the part of the illumination beam into an image beam with a second polarization direction. The image beam from the light valve travels to the PBS.

### BACKGROUND OF THE INVENTION

1. Field of the Invention

The present invention generally relates to a display module and, in particular, to an optical engine.

2. Description of Related Art

Nowadays, accompanying with the advancement of the optical projection technology, projection apparatuses being able to output large images with high resolution and high definition have been developed and widely used.

FIG. 1 is a schematic structural view of a conventional projection apparatus. Referring to FIG. 1, the conventional projection apparatus 100 includes a light source 110, a polarizing beam splitter (PBS) 120, a liquid-crystal-on-silicon panel (LCOS panel) 130, and a projection lens 140. The light source 110 is capable of emitting an illumination beam 110a. The PBS 120 is disposed on the light path of the illumination beam 110a, and reflects a part of the illumination beam 110a with an S polarization direction to the LCOS panel 130. The LCOS panel 130 coverts the part of the illumination beam 110a into an image beam 110b with a P polarization direction which passes through the PBS 120 and travels to the projection lens 140. The projection lens 140 projects the image beam 110b onto a screen (not shown) to form image frames.

The illumination beam 110a is generated from a lampwick 112 of the light source 110 and is then reflected by a reflective lampshade 114 of the light source 110. Since the brightness of the light source 110 is centered on the lampwick 112, the intensity of the rays of the illumination beam 110a near the optical axis of the illumination beam 110a is greater than that of the rays of the illumination beam 110a distant from the optical axis, which makes the center of the image frames brighter and the edge thereof darker. In this way, the image frames provided by the conventional projection apparatus 100 is nonuniform.

### SUMMARY OF THE INVENTION

Accordingly, the present invention is directed to an optical engine, which overcomes the drawbacks due to the nonuniform illumination beam.

According to an embodiment of the present invention, an optical engine including a light source, a polarizing beam splitter (PBS), a multi-focus lens, and a light valve is provided. The light source is capable of emitting an illumination beam. The PBS is disposed on the light path of the illumination beam. The multi-focus lens is disposed on the light path of the illumination beam between the light source and the PBS, and has a plurality of refractive portions. The refractive portions have different effective focal lengths (EFLs) from one another. The PBS allows at least a part of the illumination beam with a first polarization direction to travel to the light valve. The light valve is capable of reflecting the part of the illumination beam and converting the part of the illumination beam into an image beam with a second polarization direction. The image beam from the light valve travels to the PBS.

In the optical engine according to an embodiment of the present invention, the multi-focus lens uniformize the illumination beam, such that the illumination beam, when reaching the light valve, is more uniform. In this way, the drawbacks due to the nonuniform illumination beam as in the prior art is overcome.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a conventional projection apparatus.

FIG. 2A is a schematic structural view of an optical engine according to a first embodiment of the present invention.

FIG. 2B is a schematic front side view of the multi-focus lens in FIG. 2A.

FIG. 3 shows the reference regions on a light valve.

FIG. 4 shows the curves of the brightnesses with respect to the positions on the LCOS panel of the conventional projection apparatus in FIG. 1 and with respect to the positions on the light valve of the optical engine in FIG. 2.

FIG. 5 is a schematic structural view of an optical engine according to a second embodiment of the present invention.

FIG. 6 is a schematic structural view of an optical engine according to a third embodiment of the present invention.

FIG. 7 is a schematic structural view of an optical engine according to a fourth embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

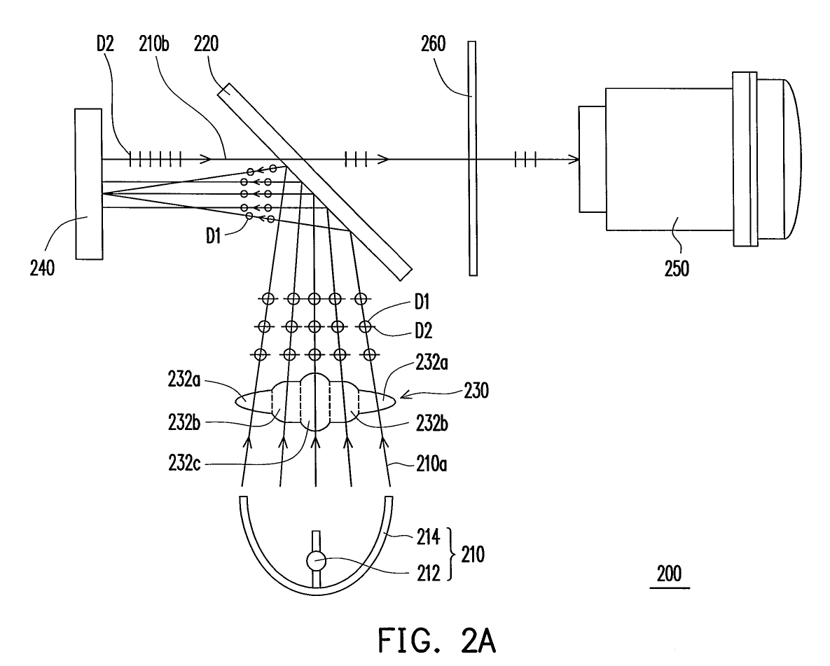

FIG. 2A is a schematic structural view of an optical engine according to a first embodiment of the present invention, and FIG. 2B is a schematic front side view of the multi-focus lens in FIG. 2A. Referring to FIGS. 2A and 2B, the optical engine 200 according to the present embodiment includes a light source 210, a polarizing beam splitter (PBS) 220, a multi-focus lens 230, and a light valve 240. The light source 210 is capable of emitting an illumination beam 210a. In the present embodiment, the light source 210 includes a lampwick 212 and a reflective lampshade 214. The lampwick 212 is used for emitting light, and the reflective lampshade 214 is used for reflecting light from the lampwick 212 into the illumination beam 210a. The lampshade 214 is, for example, an ellipsoidal reflective lampshade. However, in other embodiments (not shown), the lampshade may be a paraboloid reflective lampshade or reflective lampshades in other shapes. The PBS 220 is disposed on the light path of the illumination beam 210a. In the present embodiment, the PBS 220 is, for example, a polarizing beam splitting plate. However, in other embodiments (not shown), the PBS may be a polarizing beam splitting prism.

The multi-focus lens 230 is disposed on the light path of the illumination beam 210a between the light source 210 and the PBS 220, and has a plurality of refractive portions 232a, 232b, and 232c. The refractive portions 232a, 232b, 232c have different effective focal lengths (EFLs) from one another. In the present embodiment, the multi-focus lens 230 is, for example, an aspheric lens, and the refractive portions 232a, 232b, and 232c of the multi-focus lens 230 are coaxial. In more detail, the refractive portion 232a and 232b may be annular. The refractive portion 232a surrounds the refractive portion 232b, and the refractive portion 232b surrounds the refractive portion 232c as shown in FIG. 2B. In the present embodiment, the multi-focus lens 230 is circularly symmetric. However, in other embodiments (not shown), the multi-focus lens may be elliptically symmetric or non-circularly symmetric.

The PBS 220 allows at least a part of the illumination beam 210a with a first polarization direction D1 to travel to the light valve 240. In the present embodiment, the first polarization direction D1 is, for example, an S polarization direction, and a part of the illumination beam 210a with the first polarization direction D1 is reflected to the light valve 240 by the PBS 220. The light valve 240 is capable of reflecting the part of the illumination beam 210a and converting the part of the illumination beam 210a into an image beam 210b with a second polarization direction D2. In the present embodiment, the light valve 240 is, for example, a liquid-crystal-on-silicon (LCOS) panel. However, in other embodiments (not shown), the light valve 240 may be a digital micro-mirror device (DMD). The image beam 210b from the light valve 240 travels to the PBS 220. In the present embodiment, the second polarization direction D2 is, for example, a P polarization direction, and the image beam 210b with the second polarization direction D2 from the light valve 240 passes through the PBS 220. That is, in the present embodiment, the first polarization direction D1 is substantially perpendicular to the second polarization direction D2. However, in other embodiments (not shown), the first polarization direction D1 and the second polarization direction D2 may be the P polarization direction and the S polarization direction, respectively. Alternatively, the first and second polarization directions may be other appropriate polarization directions, respectively.

In the present embodiment, the optical engine 200 further includes a projection lens 250 to form a projection apparatus. The PBS 220 allows the image beam 210b from the light valve 240 to travel to the projection lens 250. In more detail, the image beam 210b passes through the PBS 220 and projection lens 250, and is then projected to a screen (not shown) to form image frames.

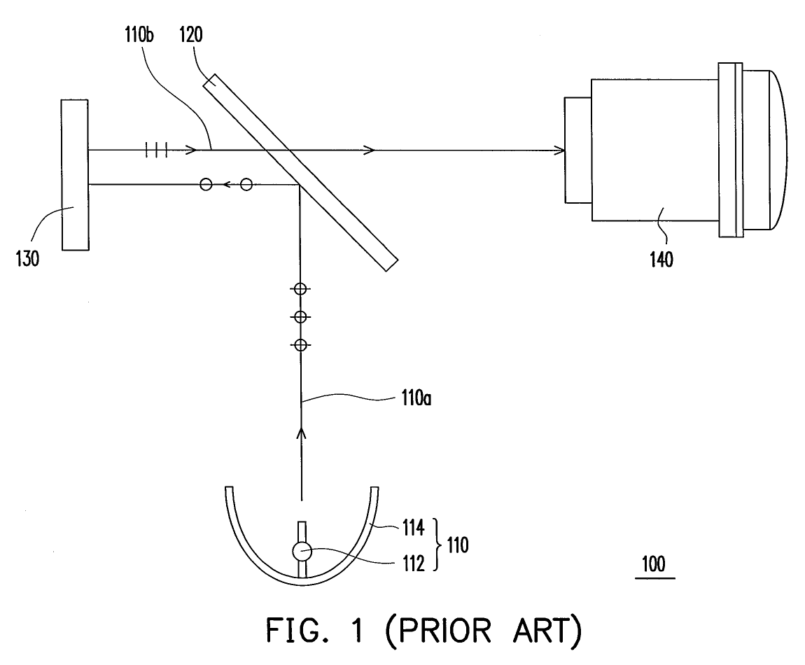

In the optical engine 200 of the present embodiment, since the optical engine 200 has the multi-focus lens 230 which has a plurality of refractive portions 232a, 232b, 232c with different EFLs, the illumination beam 210a may strike the light valve 240 more uniformly, such that the image beam 210b may be more uniform, so as to improve the brightness uniformity of the image frames projected by the optical engine 200. Therefore, the optical engine 200 overcomes the drawbacks due to the nonuniform illumination beam 110a generated by the conventional projection apparatus 100 as shown in FIG. 1. The optical simulation data is provided as follows to verify the above advantages and effects of the optical engine 200.

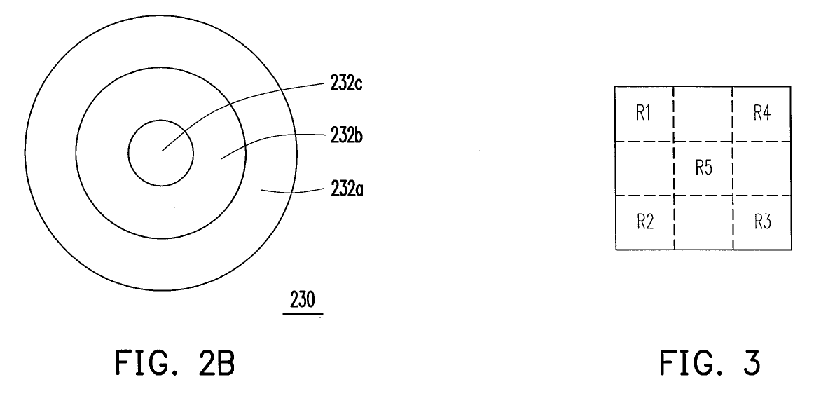

FIG. 3 shows the reference regions on a light valve. Referring to FIGS. 1, 2A, and 3, the active surface of each of the LCOS panel 130 and the light valve 240 can be divided into 9 reference regions, such as reference regions R1, R2, R3, R4, R5, etc. The brightness uniformity of the active surface of the LCOS panel 130 or the light valve 240 can be defined as follows:

Uₜₒₜₐₗ=I_{R5}/(I_{R1}+I_{R2}+I_{R3}+I_{R4})/4,

where Uₜₒₜₐₗ is the brightness uniformity of the active surface of the LCOS panel 130 or the light valve 240, I_{R1} is the average brightness of the reference region R1, I_{R2} is the average brightness of the reference region R2, I_{R3} is the average brightness of the reference region R3, I_{R4} is the average brightness of the reference region R4, and I_{R5} is the average brightness of the reference region R5. In the optical simulation, the brightness uniformity Uₜₒₜₐₗ of the active surface of the LCOS panel 130 is 34%, and the brightness uniformity Uₜₒₜₐₗ of the active surface of the light valve 240 is 71%. The brightness uniformity of the active surface of the light valve 240 of optical engine 200 is increased by 208% with respect to that of the LCOS panel 130 of conventional projection apparatus 100, which verifies that the optical engine 200 overcomes the drawbacks due to the nonuniform illumination beam 110a generated by the conventional projection apparatus 100.

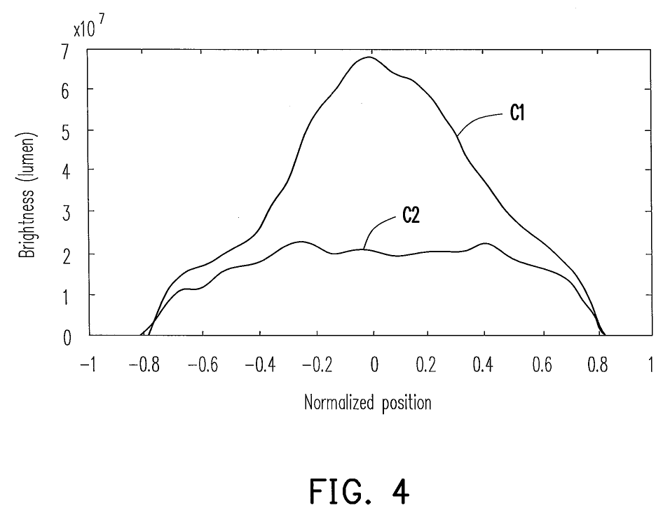

FIG. 4 shows the curves of the brightnesses with respect to the positions on the LCOS panel of the conventional projection apparatus in FIG. 1 and with respect to the positions on the light valve of the optical engine in FIG. 2A. Referring to FIGS. 1, 2A, and 4, the curve C1 in FIG. 4 shows the brightnesses with respect to the positions on the LCOS panel 130 of the conventional projection apparatus 100, and the curve C2 in FIG. 4 shows the brightnesses with respect to the positions on the light valve 240 of the optical engine 200. It is understood from the curves C1 and C2 that the brightness uniformity of the light valve 240 of the optical engine 200 is improved, which verifies again that the optical engine 200 overcomes the drawbacks due to the nonuniform illumination beam 110a generated by the conventional projection apparatus 100.

Referring to FIG. 2A, in the present embodiment, the optical engine 200 further includes an analyzer 260 disposed on the light path of the image beam 210b between the PBS 220 and the projection lens 250. The analyzer 260 is capable of allowing the image beam 210b with the second polarization direction D2 to pass through and blocking light with the first polarization direction D1. In this way, the contrast of the image frames projected by the optical engine 200 is increased.

### Second Embodiment

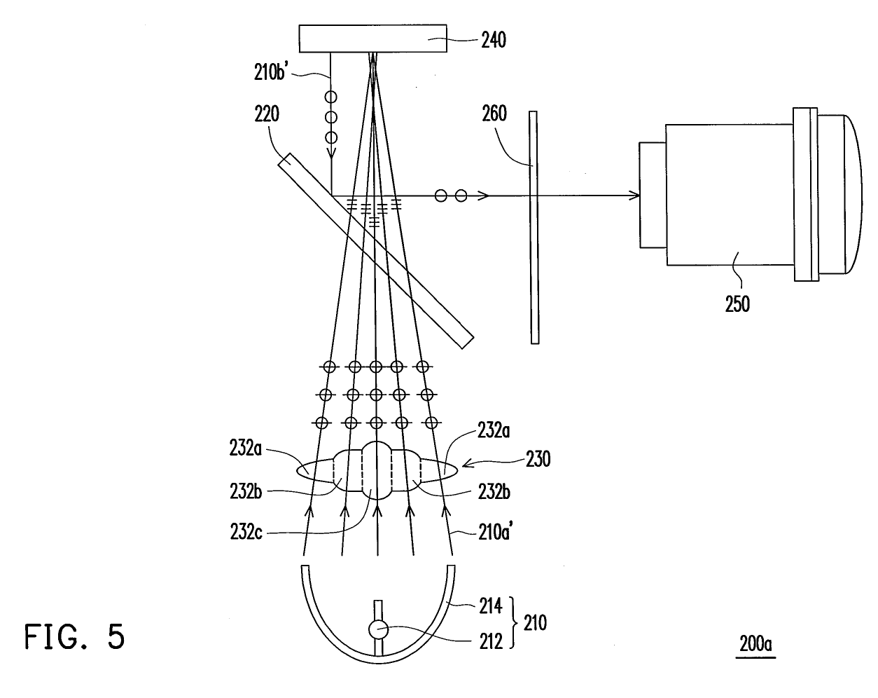

FIG. 5 is a schematic structural view of an optical engine according to a second embodiment of the present invention. Referring to FIG. 5, the optical engine 200a of the present embodiment is similar to the above optical engine 200 in FIG. 2A, and the differences therebetween are as follows. In the optical engine 200a, a part of an illumination beam 210a′ passes through the PBS 220 and travels to the light valve 240, and an image beam 210b′ from the light valve 240 is reflected by the PBS 220. In the present embodiment, the part of the illumination beam 210a′ has the P polarization direction, and the image beam 210b′ has the S polarization direction. However, in other embodiments (not shown), the part of the illumination beam 210a′ and the image beam 210b′ may have the S polarization and the P polarization direction, respectively. Alternatively, the part of the illumination beam 210a′ and the image beam 210b′ may have other appropriate polarization directions, respectively.

### Third Embodiment

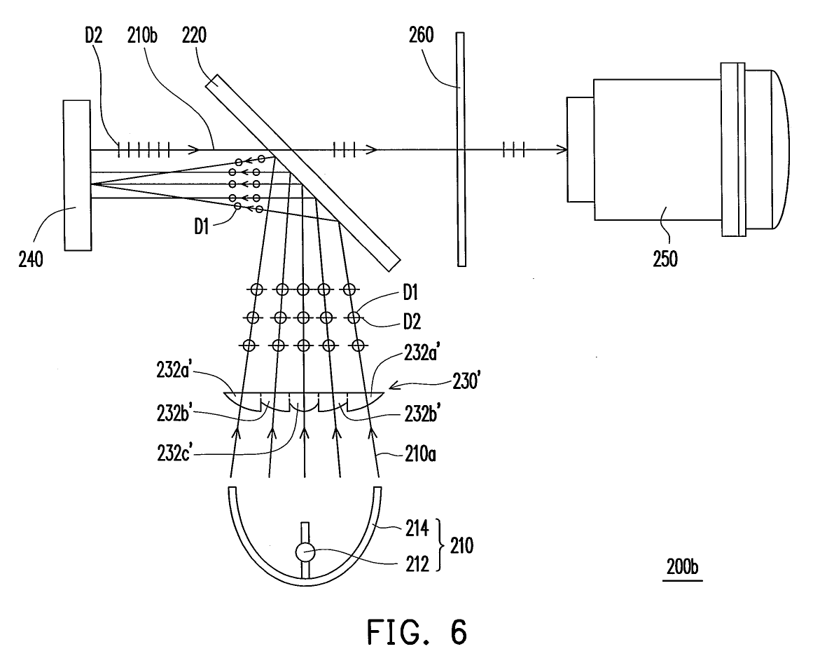

FIG. 6 is a schematic structural view of an optical engine according to a third embodiment of the present invention. Referring to FIG. 6, the optical engine 200b of the present embodiment is similar to the above optical engine 200 in FIG. 2A, and the differences therebetween are as follows. In the optical engine 200b, a multi-focus lens 230′ is a Fresnel lens, and each of refractive portions 232a′, 232b′, 232c′ is a Fresnel zone. In other words, the refractive portions 232a′, 232b′, 232c′ is coaxial, and the refractive portion 232a′ surrounds the refractive portion 232b′, and the refractive portion 232b′ surrounds the refractive portion 232a′. The EFLs of the refractive portions 232a′, 232b′, 232c′ are different, and the multi-focus lens 230′ has similar advantages and effects as those of the multi-focus lens 230 in FIG. 2A, such that the optical engine 200b has similar advantages and effects as those of the optical engine 200 in FIG. 2A.

### Fourth Embodiment

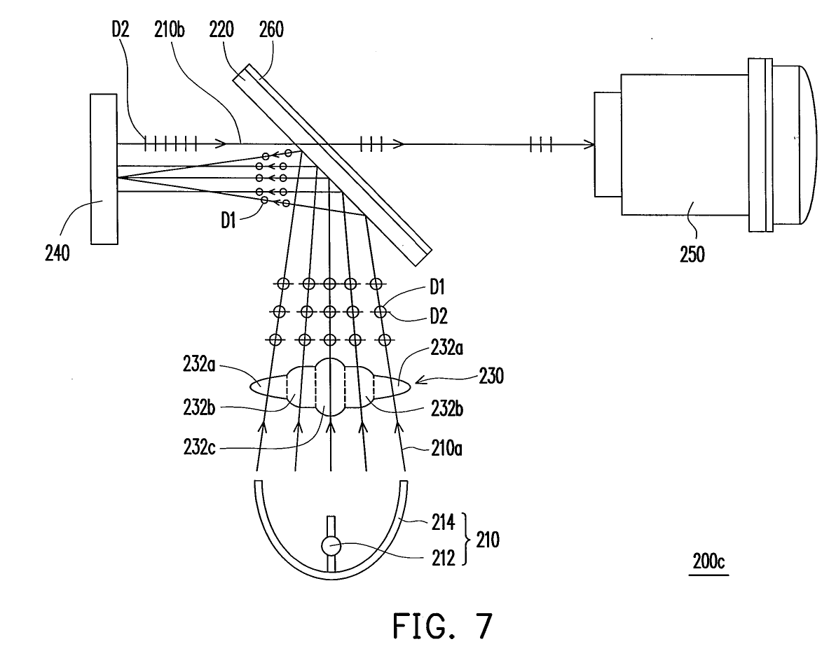

FIG. 7 is a schematic structural view of an optical engine according to a fourth embodiment of the present invention. Referring to FIG. 7, the optical engine 200c of the present embodiment is similar to the above optical engine 200 in FIG. 2A, and the differences therebetween are as follows. In the optical engine 200c, the analyzer 260 leans against the PBS 220.

It should be noted that the number of the refractive portions of the multi-focus lens 230 or 230′, such as the refractive portions 232a, 232b, 232c or the refractive portions 232a′, 232b′, 232c′, is not limited to three. In other embodiments (not shown) the number of the refractive portions of the multi-focus lens may be other positive integers other than three.

To sum up, in the optical engine according to the embodiments of the present invention, since the optical engine has the multi-focus lens which has a plurality of refractive portions with different EFLs, the illumination beam may strike the light valve more uniformly, such that the image beam may be more uniform, so as to improve the brightness uniformity of the image frames projected by the optical engine. Therefore, the optical engine in the embodiments of the present invention overcomes the drawbacks due to the nonuniform illumination beam generated by the conventional projection apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical engine, comprising:
a light source, capable of emitting an illumination beam;
a polarizing beam splitter (PBS), disposed on a light path of the illumination beam;
a multi-focus lens, disposed on the light path of the illumination beam between the light source and the PBS, and having a plurality of refractive portions, wherein the refractive portions have different effective focal lengths from one another; and
a light valve, the PBS allowing at least a part of the illumination beam with a first polarization direction to travel to the light valve, wherein the light valve is capable of reflecting the part of the illumination beam and converting the part of the illumination beam into an image beam with a second polarization direction, and the image beam from the light valve travels to the PBS.

2. The optical engine according to claim 1, wherein the part of the illumination beam is reflected to the light valve by the PBS, and the image beam from the light valve passes through the PBS.

3. The optical engine according to claim 1, wherein the part of the illumination beam passes through the PBS and travels to the light valve, and the image beam from the light valve is reflected by the PBS.

4. The optical engine according to claim 1, wherein the multi-focus lens is an aspheric lens, and the refractive portions of the multi-focus lens are coaxial.

5. The optical engine according to claim 1, wherein the multi-focus lens is a Fresnel lens, and each of the refractive portions is a Fresnel zone.

6. The optical engine according to claim 1, further comprising a projection lens, wherein the PBS allows the image beam from the light valve to travel to the projection lens.

7. The optical engine according to claim 6, further comprising an analyzer disposed on a light path of the image beam between the PBS and the projection lens, wherein the analyzer is capable of allowing the image beam with the second polarization direction to pass through and blocking light with the first polarization direction.

8. The optical engine according to claim 7, wherein the analyzer leans against the PBS.

9. The optical engine according to claim 1, wherein the first polarization direction is substantially perpendicular to the second polarization direction.

10. The optical engine according to claim 1, wherein the light source comprises:
a lampwick, for emitting light; and
a reflective lampshade, for reflecting light from the lampwick into the illumination beam.

11. The optical engine according to claim 10, wherein the reflective lampshade is an ellipsoidal reflective lampshade.

12. The optical engine according to claim 1, wherein the light valve is a liquid-crystal-on-silicon panel or a digital micro-mirror device.
